(19) United States
(12) Patent Application Publication
(10) Pub. No.: US 2026/0141805 A1
(43) Pub. Date: May 21, 2026

(54) SIGNALING SOUND LOCATION AND INTENT IDENTIFICATION

(71) Applicant: International Business Machines Corporation, Armonk, NY (US)

(72) Inventors: Su Liu, Austin, TX (US); Hamid Majdabadi, Ottawa (CA); Neil Delima, Scarborough (CA); Paul Llamas Virgen, Guadalajara (MX)

(21) Appl. No.: 18/952,160

(22) Filed: Nov. 19, 2024

(51) Int. Cl. G08G 1/0967

(52) U.S. Cl. CPC G08G 1/096791; G08G 1/096725

(57) ABSTRACT

A computer-implemented method to determine a source, intent, and target of a signlaing sound for vehicle. The method includes obtaining a set of conditions for a vehicle, where the set of conditions includes identifying at least one additional vehicle in a vicinity of the vehicle. The method further includes identifying, by a set of sensors associated with the vehicle, a signaling sound. The method also includes predicting an intent of the signaling sound. The method includes generating, based on the set of conditions, an aerial view of the vehicle. The method further includes generating, in response to the predicting, a message to the vehicle, where the message communicates the intent to a passenger in the vehicle.

### BACKGROUND

The present disclosure relates to vehicles, and, more specifically, to intelligent smart communication between vehicles.

Many modern vehicles have several modes of passing information between other vehicles. Various lights and sounds can be generated based on actions of passengers to provide information about the actions/intentions of one vehicle to other vehicles in the vicinity.

### SUMMARY

Disclosed is a computer-implemented method to determine a source, intent, and target of a signlaing sound for vehicle. The method includes obtaining a set of conditions for a vehicle, wherein the set of conditions includes identifying at least one additional vehicle in a vicinity of the vehicle. The method further includes identifying, by a set of sensors associated with the vehicle, a signaling sound. The method also includes predicting an intent of the signaling sound. The method includes generating, based on the set of conditions, an aerial view of the vehicle. The method further includes generating, in response to the predicting, a message to the vehicle, wherein the message communicates the intent to a passenger in the vehicle. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for generating and updating a display in a vehicle, in accordance with some embodiments of the present disclosure.

FIG. 2 is a block diagram of a computing environment suitable for operation of a horn manager in accordance with some embodiments of the present disclosure.

FIG. 3 is a table showing relevant data for a set of conditions and/or identified intent, in accordance with some embodiments of the present disclosure.

FIG. 4 is a flow chart of an example method to generate a message in response to being a target of a signaling sound, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as identifying a source, a target, and an intent of a signaling sound of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

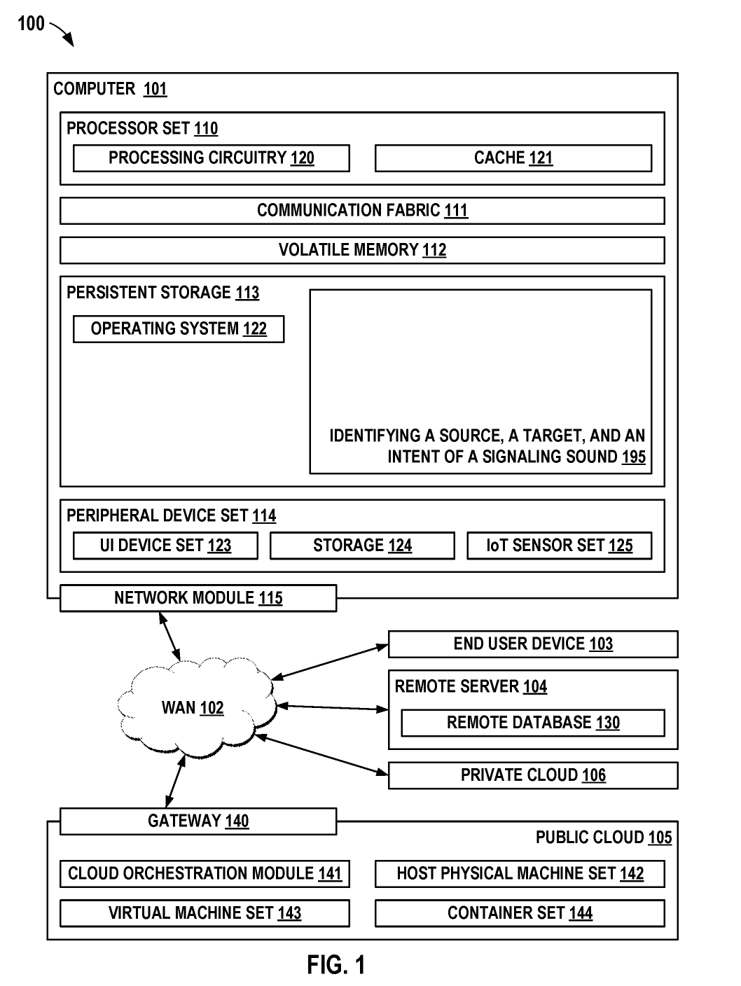

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Many modern vehicles have several modes of passing information between other vehicles. Various lights and sounds can be generated based on actions of passengers to provide information about the actions/intentions of one vehicle to other vehicles in the vicinity. However, these signals are provided to everyone generally, and nobody specifically, such as a horn being sounded. The sender may have a specific reason and/or target for the signaling sound. But everyone in the vicinity can hear the horn with an attempt to determine the intention of the initiator, and/or if they are a target of the sound. In many cases, when a driver intends to inform a particular vehicle/bystander of a specific intended message, there is no way to ensure that the intended recipient sees or hears the signal, understands the intended message, and/or is aware they are intended for the target even if they do see/hear it. Further, if a non-target of the signal interprets the message as being directed to them, it can cause confusion which can cause accidents and injury. They may also be unable to identify a source of the signaling sound. For example, in one scenario a first driver honks a horn in a busy area intending to inform a second car that a stoplight both cars are waiting for is now green and the second car can start driving. A third and/or fourth vehicle can also hear the horn and perhaps unexpectedly stops. The resulting confusion may cause an accident, or simply increase congestion.

Additionally, in various geographic locations, the patterns and/or intensity of honking or other signaling sounds can have specific meanings generally understood by a majority of persons in the area. As new drivers and/or travelers are in an area, they may be unaware of the signaling sound customs with the current location. Failure to identify and react to the local customs can also cause confusion, traffic increases, and potential accidents and property damage.

In order to better and more quickly identify source and intent of a signaling sound and to reduce confusion on roadways or transit routes, embodiments of the present disclosure can identify a source of a horn, and based on current conditions predict an intent of the initiation and/or if a particular vehicle is an intended target of the signaling sound, then generate a notification for the driver of that particular vehicle.

Embodiments of the present disclosure can include an intelligent horn management system (or horn manager). The horn manager can continuously monitor for signaling sounds emitted by other vehicles or devices in the vicinity of the vehicle and for the driving conditions surrounding the vehicle. In some embodiments, signaling sounds can be any sound intentionally generated. Examples of mechanisms that can signal sounds include car horns, loud speakers, beepers, and the like. In some embodiments, horn manager identifies a horn being sounded. In some embodiments, the identification includes determining an activation location and comparing the location to vehicle, persons, and other objects in the vicinity of the vehicle. The location can associated with another vehicle and/or object in the area.

The horn manager can analyze the honking pattern to generate an intent score. In some embodiments, the intent score represents a likelihood the signaling sound is attempting to pass a specific message. In some embodiments, the horn manager classifies the horn. Different horn lengths and patterns can be associated with various meanings. These meanings can change in various geographic regions. In some embodiments, the intent is generated from a predetermined list of intents. In some embodiments, prediction is based on the horn classification and the conditions surrounding the vehicle. In some embodiments, the intent score is generated by a learning model. The learning model can be trained to identify signaling sound patterns specific to geographic areas.

In some embodiments, the intent score can be based on comparing an expected action of a vehicle to an actual action. As the expected actions do not occur, then the intent can be associated with the action that is not being taken.

In some embodiments, the horn manager calculated a target score. The target score predicts/represent a likelihood the vehicle is a target of the signaling sound. The likelihood can be related to the predicted intention and/or the set of conditions. In some embodiments, the horn manager notifies a driver/passenger in the vehicle of the predicted intention. In some embodiments, notification can include an instruction to the driver for a recommended action. In some embodiments, the target can be associated with the vehicle not performing the expected action.

In some embodiments, the horn manager determines a source of the signaling sound. The determination can be based on a source score. In some embodiments, a source score is calculated for one or more other vehicles in the vicinity of the vehicle. The sound can be analyzed for direction and/or magnitude to determine an originating location of the signaling sound.

In some embodiments, the horn manager can combine the source score, the target score, and the intent score to generate an overall signal score. The sub-scores can be combined in any manner. The horn manager, when the overall signal score is above a threshold, notify the driver and other passengers of the vehicle, it was predicted the vehicle is a target of the sound with the predicted intention. In some embodiments, the message includes a recommended action and/or can cause an automatic action to be taken by the vehicle.

In some embodiments, the horn manager can generate a view of vehicles surroundings. The view can include the additional vehicles and items, as well as the origination location of the signaling sound. In some embodiments, the view is generated in response to any of the scores being above a threshold.

In some embodiments, the various scores are based on a set of conditions surrounding the vehicle. The horn manager can monitor the surroundings using one or more sensors associated with the vehicle and/or can monitor and/or receive data from connected IoT devices and/or other vehicles sharing data. The monitoring can identify additional vehicles in the vicinity, as well as buildings, pedestrians, animals, and other items relevant to the driving situation. In some embodiments, the vehicle monitors the surroundings with one or more sensors associated with the vehicle and/or with data collected from publicly available sources such as weather and traffic data.

The aforementioned advantages are example advantages, and embodiments exist that can contain all, some, or none of the aforementioned advantages while remaining within the spirit and scope of the present disclosure.

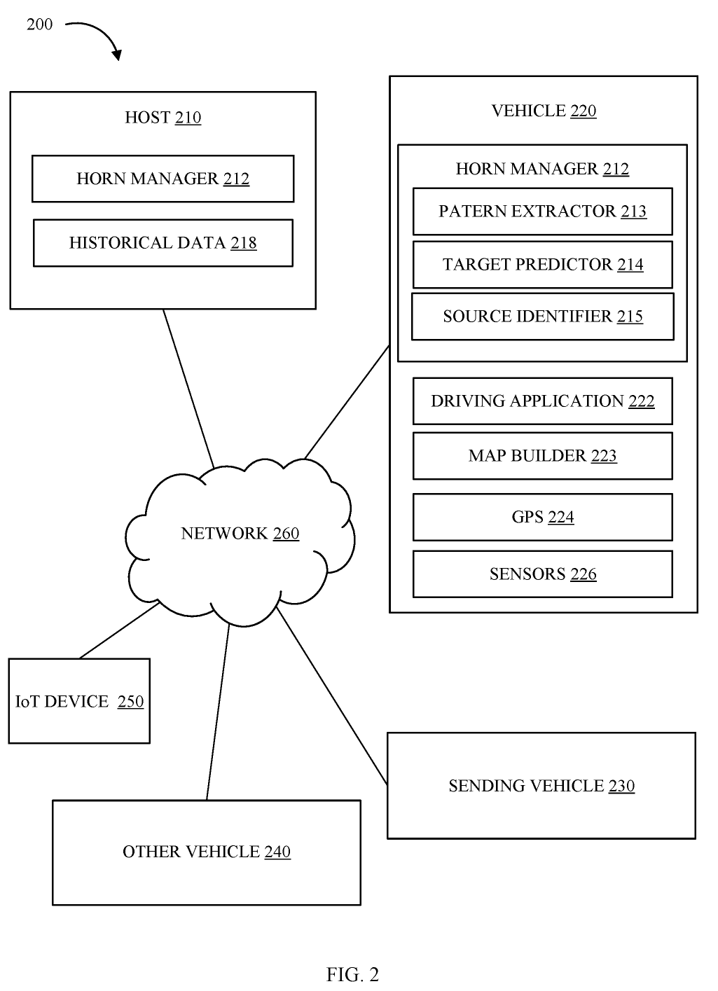

Referring now to various embodiments of the disclosure in more detail, FIG. 2 is a representation of a computing environment 200, that is capable of running a horn manager in accordance with one or more embodiments of the present disclosure. Many modifications to the depicted environment may be made by those skilled in the art without departing from the scope of the disclosure.

Computing environment 200 comprises host 210, vehicle 220, sending vehicle 230, other vehicle 240, IoT device 250 and network 260. Network 260 can be, for example, a telecommunications network, a local area network (LAN), a wide area network (WAN), such as the Internet, or a combination of the three, and can include wired, wireless, or fiber optic connections. Network 260 may include one or more wired and/or wireless networks that are capable of receiving and transmitting data, voice, and/or video signals, including multimedia signals that include voice, data, and video information. In general, network 260 may be any combination of connections and protocols that will support communications between and among host 210, vehicle 220, sending vehicle 230, other vehicle 240, IoT device 250, and other computing devices (not shown) within computing environment 200. In some embodiments, each of host 210, vehicle 220, sending vehicle 230, other vehicle 240, IoT device 250, and other devices not shown may include one or more a computer system, such as computer 101 of FIG. 1.

For purposes of this application, vehicle 220 will be considered a vehicle that is not the originator of the signaling sound. Vehicle 220 is identifying and analyzing the sound, sending vehicle 230 will be the source of the sound, and, and other vehicle 240 will be in the vicinity of vehicle 220. However, in various embodiments, each of the vehicles can perform any or all of the functions of the others. For example, if there are three vehicles driving, and one honks it would be sending vehicle 230. Then a few minutes later, a different one honks, it will be the sending vehicle 230 for that sound. In some embodiments, any vehicle in the area can be monitoring for and identifying any signaling sound. At different times and/or locations each vehicle can include the functionality and perform any/all the functions of any of the vehicles. In some embodiments, multiple vehicles can analyze the sounds and present the same or different information to passengers in each respective vehicle. The different conditions surrounding the different vehicles can have different predictions on whether the sound is directed at each vehicle, as an example However, in this application, vehicle 220 will be described as the vehicle receiving and interpreting the sound that is initiated by sending vehicle 230.

Vehicle 220 can be any engine powered vehicle. In some embodiments, vehicle 220 can be any machine that is propelled by an engine. Each vehicle can include one or more combustion and/or electric engines. The vehicle can be an automobile, a bicycle, an all-terrain vehicle, farm equipment, watercraft, and any other type of movable machine. In some embodiments, vehicle 220 has some level of automation/self-driving capability. Each vehicle can include a computing device to manage the automation of the vehicle. In some embodiments, vehicle 220 includes horn manager 212, driving application 222, map builder 223, GPS 224,and sensors 226.

Horn manager 212 can be any combination of hardware and/or software configured to monitor for and identify a signaling sound and predict/identify an intent and if the sound is being directed to vehicle 220. In some embodiments, horn manager 212 monitors and analyzes sounds in the vicinity of vehicle 220, and determines a source, a pattern, and a target(s) of the sound. In some embodiments, horn manager 212 includes pattern extractor 213, target predictor 214, and source identifier 215.

In some embodiments, horn manager 212 can determine a set of conditions surrounding vehicle 220. The determining the set of conditions can include identifying one or more vehicles and/or pedestrians in the vicinity of vehicle 220. The identification can be based on data received from one or more sensors 226, IoT device 250, host 210, sending vehicle 230, and/or vehicle 240. In some embodiments, the identification is based on a relative distance between sending vehicle 220 and any/all other vehicle 240. In some embodiments, the identification is based on a communicative coupling between two or more vehicles. For example, any vehicle that determine the presence of another vehicle can establish a network connection through network 260.

In some embodiments, horn manager 212 includes one or more learning models. The one or more learning models can be used by one or more of pattern extractor 213, target predictor 214, and source identifier 215. Each of the components within horn manager 212 can have a separate learning model and/or combined with one or more of the other subcomponents.

In some embodiments, horn manager 212 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, horn manager 212 execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Source identifier 215 can be any combination of hardware and/or software configured to identify a source of the signaling sound. In some embodiments, source identifier obtains data from one or more sensors 226 on vehicle 220. The data can be analyzed to predict a direction and distance of the source. From the predictions, a source can be determined. In some embodiments, source score identifies a source score for all vehicles in the vicinity of vehicle 220. The vehicle with the highest source can be determined to be sending vehicle 230. In some embodiments, if the source score for any vehicle is not above a source threshold, then no source is determined.

Pattern extractor 213 can be any combination of hardware and/or software configured to predict an intent associated with the signaling sound. In some embodiments, the predicted intent is selected from a list of predetermined intents. In some embodiments, the intent is based on the set of conditions surrounding vehicle 220. In some embodiments, the intent is based on the source of the signaling sound. In some embodiments, pattern extractor 213 includes and/or receives an output from one or more learning models.

In some embodiments, the intent can be based on a pattern of the signaling sound. The pattern can include length of sound, number of sounds, interval between, and the like. For example, a three second honk can have a different intent than three one second honks. In some embodiments, the location of vehicle 220 can change a meaning/interpretation of the honks. The training data for the one or more associated learning models can be trained to differentiate the various patterns and locations.

Target predictor 214 can be any combination of hardware and/or software configured to predict/determine if vehicle 220 is a target of the signaling sound. In some embodiments, target predictor 214 generates a target score. The target score is a likelihood that vehicle 220 is a target of the signaling sound. The target score can be based on the set of conditions, the location/movement of vehicle 220, sending vehicle 230, and/or other vehicle 240, and/or the or the intent determined by pattern extractor 213. In some embodiments, the target score is independent of the source score or the intent score(s).

In some embodiments, horn manager 212 can utilize one or more of the source scores, the intent score, and the target scores to predict when vehicle 220 is an intended target of a specific message from sending vehicle 230. In some embodiments, horn manager 212 can combine the source score, intent score and/or target score to generate an overall signaling score. The various scores can be weighted in any manner to generate the overall signaling score. The overall signaling score being above a threshold causes horn manager 212 to generate a message and/or take an action in vehicle 220.

Driving application 222 can be any combination of hardware and/or software configured to automate at least a portion of vehicle 220. The automation can be any level of automation. In some embodiments, driving application 222 can automate one or more of accelerating, decelerating, maintaining velocity, maintaining distance, steering, changing lanes, parking, and the like. In some embodiments, the driving application can manage an automated function in the vehicle unrelated to driving. This can include turning on/off attached equipment, passenger comfort actions, communications, and the like. In some embodiments, horn manager 212 provides instructions to driving application 222 to perform an action to vehicle 220 based on the analysis of an identified sound.

Map builder 223 can be any combination of hardware and/or software configured to generate a visual view of vehicle 220. In some embodiments, map builder 223 generates a 360 degree birds eye view of vehicle 220, sending vehicle 230, and/or other vehicle 240. The view of vehicle 220 can include identifiers for the source of the signaling sound as determined by source identifier 215. In some embodiments, the source is indicated in response to the source score being above the source threshold. The view can be based on the set of conditions surrounding vehicle 220. In some embodiments, the view is generated in response to identifying a signaling horn. In some embodiments, the view is generated is in response to the target score being above the target threshold.

GPS 224 can be any combination of hardware and/or software configured to determine a location of vehicle 220. In some embodiments, GPS 224 can use one or more of satellites, triangulation, networks, and other similar methods to determine the location. In some embodiments, GPS 224 can track the geolocation of each vehicle. The location data can be sent to one or more of horn manager 212, driving application 222, and/or historical data 218.

Sensors 226 can be any combination of hardware and/or software configured to gather data within and/or surrounding a vehicle 220. Vehicle 220 can include any number of sensors and any number of types of sensors. In some embodiments, the type of sensor includes one or more of cameras, thermometers, heat detectors, moisture detectors, motion detections, microphones, distance detectors, and the like. The number and type of sensors can be configured to gather enough data to identify environmental and traffic conditions outside the vehicle, and the number of passengers and/or other relevant information from inside vehicle 220. In some embodiments, the various sensors can be placed in various locations around and within the vehicle 220. In some embodiments, data from sensors 226 can be sent to horn manager 212. In some embodiments, the data from sensors 226 can be used to determine condition changes inside and outside the vehicle 220.

In some embodiments, vehicle 220, sending vehicle 230, and/or other vehicle 240 utilize a smart device (e.g., smartphone) within a vehicle and/or a pedestrian. The smart device can be associated with a driver/passenger currently in vehicle 220. The smart device can include all or some of the functionality of vehicle 220 and provide the capability to send the horn message to sending vehicle 230. In these embodiments, the smart device can interface with vehicle 220 to send the message to sending vehicle 230.

Sending vehicle 230 can be any engine powered vehicle. In some embodiments, sending vehicle 230 can be any vehicle identified as the source of the signaling horn. The identification can be based on the source score. For example, the vehicle with the highest source score can be the sending vehicle 230. In some embodiments, sending vehicle 230 can include all and/or any subset of the subcomponents of vehicle 220 and vehicle 220 can include all and/or any subset of the subcomponents of sending vehicle 230. In some embodiments, sending vehicle 230 can be any machine that is propelled by an engine. Each vehicle can include one or more combustion and/or electric engines. The vehicle can be an automobile, a bicycle, an all-terrain vehicle, farm equipment, watercraft, and any other type of movable machine. In some embodiments, sending vehicle 230 has some level of automation/self-driving capability. Each vehicle can include a computing device to manage the automation of the vehicle.

Other vehicle 240 can be any engine powered vehicle. In some embodiments, other vehicle 240 can be any vehicle identified in the vicinity of vehicle 220. The vicinity can be any distance capable of broadcasting a horn to vehicle 220. In some embodiments, the vicinity can be a predefined distance (e.g., 300 yards). In some embodiments, the vicinity can be any vehicle identified by sending vehicle 220. The identification can be based on location (e.g., GPS data), sensor identification, connection to a network, and the like. In some embodiments, other vehicle 240 can include all and/or any subset of the subcomponents of vehicle 220 and/or sending vehicle 230, and vehicle 220 and/or sending vehicle 230 can include all and/or any subset of the subcomponents of other vehicle 240.

In some embodiments, other vehicle 240 can be any machine that is propelled by an engine. Each vehicle can include one or more combustion and/or electric engines. The vehicle can be an automobile, a bicycle, an all-terrain vehicle, farm equipment, watercraft, and any other type of movable machine. In some embodiments, sending vehicle 220 has some level of automation/self-driving capability. Each vehicle can include a computing device to manage the automation of the vehicle.

In some embodiments, other vehicle 240 and/or sending vehicle 230 can be a pedestrian not in a moving vehicle. The pedestrian can be adjacent to or near vehicle 220. In these embodiments, the personal computing device (e.g., smartphone) or other object (e.g., voice, megaphone, etc.) that can emit a signaling sound.

IoT device 250 can be any combination of hardware and/or software configured to gather data in the vicinity of vehicle 220. In some embodiments, any device that can capture and/or send data related to vehicle and pedestrian traffic patterns can be considered IoT device 250. In some embodiments, IoT device 250 can represent two or more separate IoT devices. Each IoT device 250 can have one or more sensors. The sensor can include cameras, heat sensors, motion detectors, and the like. In some embodiments, IoT device 250 can be embedded into vehicles, personal electronic devices (e.g., smartphones, smartwatches, smart glasses, etc.), and infrastructure (e.g., stop lights, cameras, buildings).

In some embodiments, IoT device 250 may include computerized devices, such as personal computers, smartphones, servers, or the like. Two such devices may be networked together when one device is able to exchange information with the other device, whether or not they have a direct connection to each other. Two such devices may exchange data with each other using network 260.

In some embodiments, IoT device 250 sends data to horn manager 212. The data can be used as inputs into target score, intent score, and /or source score. In some embodiments, the IoT device 250 can include pre-existing devices (e.g., such as traffic pattern cameras) that are configured to send data to horn manager 212.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., public cloud 105 or private cloud 106). In some embodiments, host 210 includes horn manager 212 and historical data 218. In some embodiments, host 210 can generate the scores for one or more vehicles as if it is sending vehicle 220.

In some embodiments, host 210 and/or all or some of its subcomponents can be included in one or more of vehicle 220, sending vehicle 230, and other vehicle 240 in any combination. In some embodiments, host 210 can train the one or more learning models and then send the trained and updated models to vehicle 220.

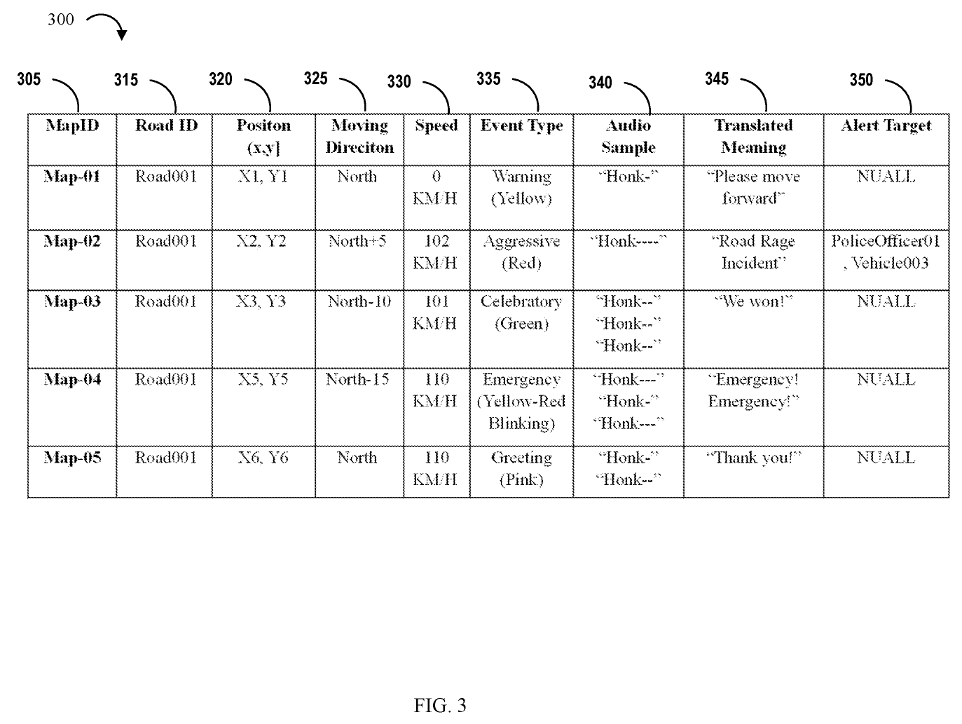

Historical data 218, can be data related to signal sending scenarios. In some embodiments, historical data 218 can include data that is used to train the one or more learning models associated with horn manager 212. Data can include the set of conditions, local customs (horn patterns), The data can include horn activations, the location/movement data for other vehicles, reactions to the activation, and the like. FIG. 3 includes one example embodiment of some of the data that can be stored in historical data 218. In some embodiments, vehicle 220 sends data relating to the set of conditions periodically to be added to the training data.

FIG. 3 includes one example embodiment of conditions and/or identified intent that can be stored in historical data 218. FIG. 3 includes table 300 with columns MapID 305, RoadID 315, Position 320, Moving Direction 325, Speed 330, Event Type 335, Audio Sample 340, Translated Meaning 345 (e.g., predicted intent), and Alert Target 350. In some embodiments, additional data that is not shown can be included. For example, there can be additional tables and/or columns can include vehicle id, driver id, the scores, and other relevant data. As shown, for a particular time (e.g., row) the table 300 shows a set of relevant data related to location, what an intended message can be, and potential targets.

In some embodiments, data stored in table 300 can be used to train the one or more learning models in horn manager 212. In some embodiments, the set of conditions can be added to table 300 and/or stored in a separate table.

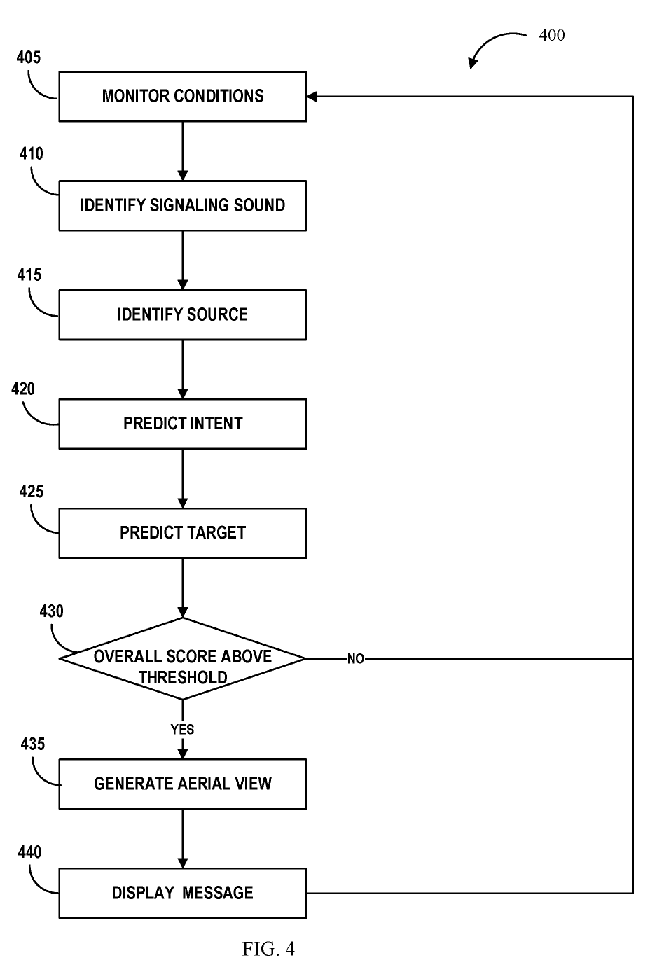

FIG. 4 is a flowchart of an example process 400 for displaying a message in a vehicle that is a target of a signaling sound in a computing environment (e.g., computing environment 100 and/or computing environment 200). One or more of the advantages and improvements described above for displaying a message in a vehicle that is a target of a signaling sound may be realized by process 400, consistent with various embodiments of the present disclosure.

Process 400 can be implemented by one or more processors, host 210, horn manager 212, pattern extractor 213, target predictor 214, source identifier 215, historical data 218, driving application 222, map builder 223, GPS 224, sensors 226, sending vehicle 230, other vehicle 240, IoT device 250, and/or a different combination of hardware and/or software. In various embodiments, the various operations of process 400 are performed by one or more of host 210, horn manager 212, pattern extractor 213, target predictor 214, source identifier 215, historical data 218, driving application 222, map builder 223, GPS 224, sensors 226, sending vehicle 230, other vehicle 240, and/or IoT device 250. For illustrative purposes, the process 400 will be described as being performed by horn manager 212.

At operation 405, horn manager 212 monitors conditions surrounding vehicle 220. In some embodiments, the monitoring includes determining the set of conditions. The set of conditions can include identifying other vehicles (e.g., sending vehicle 230 and other vehicle 240), determining the location of vehicle 220, speed, driving direction, weather conditions, time (e.g., time of day, day of week, etc.), non-vehicle objects (e.g., pedestrians, buildings, trains, etc.) and other relevant conditions. In some embodiments, the set of conditions are based on data received by sensors 226 and/or from external sources such as IoT device 250 and sending vehicle 230. In some embodiments, data is received from historical data 218. In some embodiments, the set of conditions are stored in historical data 218 to at a predetermined frequency.

At operation 410, horn manager 212 identifies a signaling sound. In some embodiments, the signaling sound is generated by sending vehicle 220 and/or a device not associated with a vehicle. In some embodiments, determination is based on data collected at one or more sensors on vehicle 220. The sensors can be microphones placed at different locations on vehicle 220. In some embodiments, the signaling sound is a horn from sending vehicle 230. In some embodiments, the horn can be a signaling sound if is above a volume threshold. In some embodiments, the signaling sound can be more than one distinct sound. For example, horn manager 212 can identify a length (overall and for each sub sound), number of sounds, and/or volume. The number of sounds can be three successive beeps of similar length, as an example. The three separate beeps can be considered the signaling sound as a whole. In some embodiments, horn manager 212 determines a start and a stop of the signaling sound including intervals of any smaller units (beeps) in the signaling sound.

At operation 415, horn manager 212 identifies a source of the signaling sound. horn manager 212 can analyze the sound signatures collected in operation 410. By comparing the time the sound was received at each individual sensor, horn manager 212 can determine a direction and a relative distance of the source of the sound. In some embodiments, horn manager 212 compares the collected horn data against the set of conditions to determine a likely source. In some embodiments, the type of sound can be a factor in the source score. For example, if the signaling sound is determined to be a horn from a vehicle, the source score for vehicles would be relatively higher than non-vehicle object, such as bicyclist.

In some embodiments, operation 415 includes calculating a source score. A unique source score can be determined for each identified vehicle and/or object/pedestrian. The source score represents a likelihood that a particular object(e.g., vehicle, pedestrian, etc.) is the source of the signaling sound. The total sum of all the source scores can equal 1.00. In some embodiments, the object with the highest source score can be determined as the source. In some embodiments, the source is based on the object’s source score being above a source threshold.

At operation 420, horn manager 212 predicts an intent of the signaling sound. The intent is a predicted message the originator is intending to send to one or more objects. The intent can be based on the monitored set of conditions. In some embodiments, the intent score can be based on the length of the signaling sound. The length can include length, number, and/or volume of the sound. In some embodiments, the intent can be selected from a predetermined list of intents. The list can include stop, go, emergency, notice, warning, and other intents.

In some embodiments, the intent is based on comparing an expected action of the vehicles to an actual action. The greater the difference between an expected action and an actual action the higher the intent score. The intent is based on the expected action. For example, if a car is waiting at a red light, the light turns green, it is expected the car will start to drive. The longer the car is still at a green light, the greater the difference between an expected action and the actual action. If a signaling sound is heard, then one intent can be to inform the non-moving vehicle that they can proceed.

In some embodiments, the intent score is based on comparing the identified sound to known signaling sounds. If a particular geographic region use a similar signal to send a similar message, that can increase the intent score.

In some embodiments, the intent score is generated by one or more learning models. The set of conditions is the input of the learning model. The learning model can determine the difference between actual and expected actions and output an intent score.

At operation 425, horn manager 212 predicts a target for the signaling sound. In some embodiments, operation 425 includes calculating a target score. The target score represents a likelihood an object is a target of the signaling sound. In some embodiments, the target score is calculated for all or some of the identified objects. In some embodiments, the target score is calculated only for vehicle 220. If the target score is above a threshold, then the associated object can be determined/predicted to be a target of the signaling sound.

In some embodiments, the target score is generated by one or more learning models. In some embodiments, the determined intent and/or the source can be factors in the target score. For example, if sending vehicle 230 is further away than other vehicle 240, then the target score for vehicle 220 can be relatively lower than the target score for other vehicle 240. If horn manager 212 were only calculating one target score, then the presences of other vehicle 240 in between could cause a relatively lower target score compared to if other vehicle 240 was not present. Another example, if the intent is determined to be signaling a stop light is green, but vehicle 220 is waiting at an adjacent red light then the target score would be relatively low compared to a vehicle not moving in front of a green traffic signal.

At operation 430, horn manager 212 determines if the overall signaling score as above a signaling threshold. And some embodiments, operation 430 includes calculating the overall signaling score. The overall signaling score it's based on one or more of the source score, the intent scores (and/or the determined intent), and the target scores. The various scores can be combined and/or weighted and any way. In some embodiments, the target score is most heavily weighted score.

If the overall signaling score is above the signaling threshold (430:YES), then horn manager 212 proceeds to operation 435. If the overall signaling score is not above the signaling threshold (430:NO), then horn manager 212 returns to operation 405.

At operation 435, horn manager 212 generates an aerial view of vehicle 220. In some embodiments, the aerial view is displayed on a screen visible to passengers withing vehicle 220. The screen can be integrated into vehicle 220 and/or associated with a device located int eh vehicle (e.g., smartphone.). The aerial view can display vehicle 220, sending vehicle 230, other vehicle 240 and/or other identified objects. In some embodiments, sending vehicle 230 (or the identified source of the sound) can be specifically indicated in the aerial view (e.g., different color). In some embodiments, the aerial view includes other data from the set of conditions, such as speed and direction traveling as an example. In some embodiments, the aerial view is shown before an identification of the signaling sound and/or if the overall signaling score is below the signaling threshold.

At operation 440, horn manager 212 displays a message. In some embodiments, the message can be incorporated into the aerial view. In some embodiments, the message includes the source, the predicted intent, the target, and/or a recommended action. The recommended action can be based on the intent. In some embodiments, the recommended action can be based on the difference between the actual and the expected event. The recommended action can be configured to reduce the difference between toe actual and the expected event for vehicle 220.

In some embodiments, the message is configured to cause vehicle 220 to take an automatic action. The automatic action can be performed by driving application 222. For example, if the signaling sound is determined to be an ambulance with vehicle 220 as a target. The message can cause vehicle 220 to slow down and change lanes to allow the ambulance to pass.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a set of conditions for a vehicle, wherein the set of conditions includes identifying at least one additional vehicle in a vicinity of the vehicle;
identifying, by a set of sensors associated with the vehicle, a signaling sound;
predicting an intent of the signaling sound;
generating, based on the set of conditions, an aerial view of the vehicle; and
generating, in response to the predicting, a message to the vehicle, wherein the message communicates the intent to a passenger in the vehicle.

2. The computer-implemented method of claim 1, further comprising:
determining the vehicle is a target of the signaling sound, wherein the generating the message is in response to the determining the vehicle is a target of the signaling sound.

3. The computer-implemented method of claim 2, wherein the determining the vehicle is the target of the signaling sound further comprises:
calculating, based on the intent and the set of conditions, a target score; and
determining the target score is above a target threshold for the vehicle.

4. The computer-implemented method of claim 2, further comprising:
identifying a source of the signaling sound, wherein the aerial view includes a location of the source of the signaling sound.

5. The computer-implemented method of claim 4, wherein the identifying the source further comprises:
calculating, based the set of conditions, a source score for the additional vehicle; and
determining the source score is above a source threshold for the additional vehicle.

6. The computer-implemented method of claim 5, wherein the predicting the intent is in response to the identifying the source of the signaling sound.

7. The computer-implemented method of claim 1, wherein the predicting the intent is performed by one or more learning models.

8. The computer-implemented method of claim 1, wherein the intent is selected from a predetermined list of intents.

9. The computer-implemented method of claim 1, wherein the message includes a recommended action of a driver the vehicle.

10. The computer-implemented method of claim 9, wherein the vehicle automatically performs the recommended action.

11. A system comprising:
a processor; and
a computer readable storage medium communicatively coupled to the processor and storing program instructions which, when executed by the processor, are configured to cause the processor to:
obtain a set of conditions for a vehicle, wherein the set of conditions includes identifying at least one additional vehicle in a vicinity of the vehicle;
identify, by a set of sensors associated with the vehicle, a signaling sound;
predict an intent of the signaling sound;
generate, based on the set of conditions, an aerial view of the vehicle; and
generate, in response to the predicting, a message to the vehicle, wherein the message communicates the intent to a passenger in the vehicle.

12. The system of claim 11, wherein the program instruction are further configured to cause the processor to:
determine the vehicle is a target of the signaling sound, wherein the generating the message is in response to the determining the vehicle is a target of the signaling sound.

13. The system of claim 12, wherein the program instruction are further configured to cause the processor to:
calculate, based on the intent and the set of conditions, a target score; and
determine the target score is above a target threshold for the vehicle.

14. The system of claim 12, wherein the program instruction are further configured to cause the processor to:
identify a source of the signaling sound, wherein the aerial view includes a location of the source of the signaling sound.

15. The system of claim 11, wherein the intent is predicted by one or more learning models.

16. A computer program product, the computer program product comprising a computer readable storage medium having program instructions embodied therewith, the program instructions executable by a processing unit to cause the processing unit to:
obtain a set of conditions for a vehicle, wherein the set of conditions includes identifying at least one additional vehicle in a vicinity of the vehicle;
identify, by a set of sensors associated with the vehicle, a signaling sound;
predict an intent of the signaling sound;
generate, based on the set of conditions, an aerial view of the vehicle; and
generate, in response to the predicting, a message to the vehicle, wherein the message communicates the intent to a passenger in the vehicle.

17. The computer program product of claim 16, wherein the program instruction are further configured to cause the processing unit to:
determine the vehicle is a target of the signaling sound, wherein the generating the message is in response to the determining the vehicle is a target of the signaling sound.

18. The computer program product of claim 17, wherein the program instruction are further configured to cause the processing unit to:
calculate, based on the intent and the set of conditions, a target score; and
determine the target score is above a target threshold for the vehicle.

19. The computer program product of claim 17, wherein the program instruction are further configured to cause the processing unit to:
identify a source of the signaling sound, wherein the aerial view includes a location of the source of the signaling sound.

20. The computer program product of claim 16, wherein the intent is predicted by one or more learning models.
